(19) United States
(12) Patent Application Publication
(10) Pub. No.: US 2006/0254289 A1
(43) Pub. Date: Nov. 16, 2006

(54) Vacuum device

(76) Inventors: Dirk Schiller, Hurth (DE); Ernst Schnacke, (US); Holger Dietz, (US)

Correspondence Address: Thomas E. Kocovsky, Jr.;Fay, Sharpe, Fagan, Minnich & Mckee, 1100 Superior Avenue, Seventh Floor, Cleveland, OH, 44114-2579, US

(21) Appl. No.: 10/568,565

(22) PCT Filed: Jul. 14, 2004
(86) PCT No.: PCT/EP04/07764

§ 371 Date: Feb. 17, 2006

Related U.S. Application Data
(60) Provisional application No. 60/496,998, filed on Aug. 20, 2003.

(51) Int. Cl. B01D 8/00

(52) U.S. Cl. 62/55.5

(57) ABSTRACT

A vacuum device comprises a plurality of cryopumps (10), particularly a plurality of cryopumps connected in parallel. Further, at least one compressor device (16) is provided which is connected to the cryopumps (10) via medium supply conduits (12). A medium return conduit (14) is also connected to the compressor device (16) and the cryopumps (10). Arranged between the medium supply conduit (12) and the medium return conduit (14) is a storage container (20) for medium. Further, a pressure measurement device (30) is provided in the medium supply conduit (12). The pressure measurement device (30) is connected, via a control unit (32), to a supply valve (26). To keep the pressure difference at the cryopumps (10) as constant as possible, the supply valve (26) is opened when a threshold value of the pressure in the medium supply conduit (12) is exceeded, thus causing medium to flow into the storage container (20).

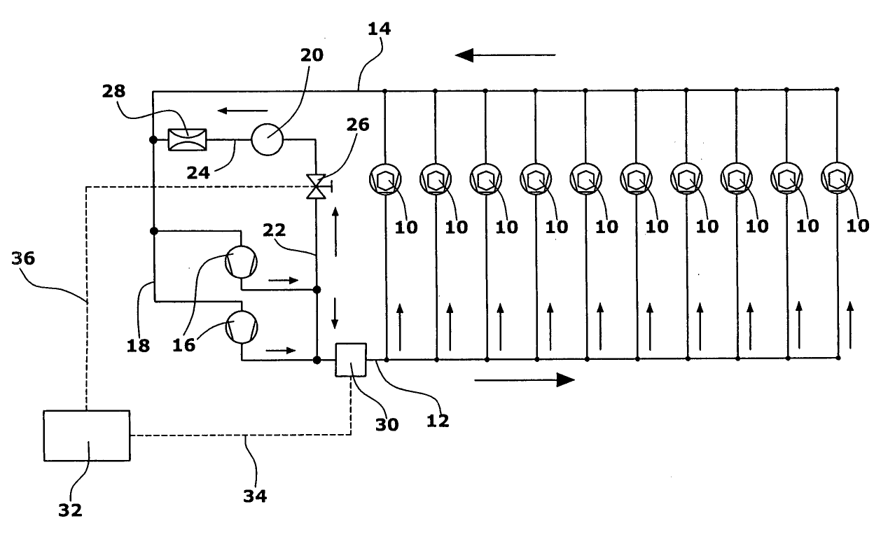

### BACKGROUND

The present invention relates to a vacuum device, particularly a vacuum device comprising a plurality of cryopumps for refrigeration.

Vacuum devices of the type discussed here comprise a plurality of cryopumps arranged e.g. in parallel to each other. The cryopumps are connected, via medium supply conduits, to a compressor device. When cryopumps are employed for refrigeration, the medium normally used will be helium. The helium is compressed by means of a compressor and is expanded internally of the cryopumps, thus generating refrigeration. Further, the cryopumps have medium return conduits connected thereto for returning the medium to the compressor. If required, intermediary cleansing units are provided to cleanse the medium of e.g. oil or other impurities which have been taken up by the medium during its passage through the compressor.

During operation, for obtaining the best possible refrigeration capacity at an individual cryopump or all of the cryopumps, the pressure difference at the individual cryopumps should be as large as possible. In this regard, a problem resides in that an increase of the number of active refrigerating pumps in the refrigeration device will cause the pressure difference to become correspondingly smaller. This will result in a decrease of the pressure difference. Also, cold cryopumps tend to “bind” a considerable quantity of gas. This in turn will cause a further decrease of the pressure difference.

For keeping the pressure difference at cryopumps during operation as constant as possible, it is known according to U.S. Pat. No. 6,530,237 to provide a storage container for a refrigerating medium, e.g. helium. The storage container is connected to the medium supply conduits and the medium return conduits via connection conduits. Both in the high-pressure conduit, i.e. the medium supply conduit, and in the low-pressure conduit, i.e. the medium return conduit, a pressure measurement device is provided which is connected to a control unit. The storage container is arranged between the two pressure measurement devices. Using the control unit, the difference between the two measured pressures is detected. In case of a change of the pressure difference, a quantity of the medium will either be supplied to the system from the storage container or be removed from the system. Since the system described in U.S. Pat. No. 6,530,237 is provided with a respective pressure measurement device both in the medium supply conduit and in the medium return conduit and requires that two measured pressures be compared to each other, this prior art system is relatively expensive and complex.

### SUMMARY

It is an object of the invention to provide a vacuum device in which the pressure difference at the cryopumps provided in the vacuum device can be kept constant in a simple manner. A further object of the invention resides in the provision of a simple and inexpensive control method for the vacuum device.

The present vacuum device, comprising a plurality of refrigeration devices connected in parallel, is according to the invention provided with only one pressure measurement device in the medium supply conduit via which the refrigerating medium, preferably helium, is supplied to the refrigeration devices. Thus, no pressure measurement device is provided in the medium return conduit. Accordingly, no comparison will have to be performed between two measurement means. Of course, the vacuum device can comprise further pressure measurement means, e.g. for measuring the pressure in the storage container. According to the invention, however, only a sole pressure measurement device is provided in the medium supply conduit for maintaining the pressure difference in the refrigeration devices at a substantially constant level. In the present context, the term “constant” is to be understood in the sense of a pressure difference varying by no more than 25%, particularly less than 20%.

According to an alternative embodiment, a pressure measurement device is provided only the medium return conduit. This embodiment does not comprise a pressure measurement device in the medium supply conduit.

By the inventive provision of only one pressure measurement device, the costs for production and installation of a second pressure measurement device are avoided. In this manner, also the costs for maintenance and renewal are advantageously reduced.

The refrigeration devices are particularly provided as cryopumps or refrigeration heads. The invention will be described in greater detail hereunder with reference to cryopumps; it is understood, however, that these can be replaced by refrigeration heads.

According to the invention, a preferably constant medium flow is generated by the one compressor device or, if provided, by a plurality of compressor devices arranged in parallel to each other. As a result, pressure is built up in the medium supply conduit. As soon as this pressure exceeds a threshold value, particularly a predetermined maximum threshold value, a supply valve arranged in the connection conduit between the medium supply conduits and the storage container will be opened, thus causing an inflow of medium into the storage container. If the pressure measured by the pressure measurement device falls below a threshold value, particularly a predetermined minimum threshold value, the valve will be closed again to prevent an excess flow of gas into the storage container and a resultant too small pressure difference between the supply and return conduits.

Since also the medium return conduit is connected to the storage container, a suitable pressure difference may cause medium to flow from the storage container into the medium return conduit. In this regard, it is possible to provide the connection conduit between the storage container and the refrigeration devices with a valve adapted to be switched in a corresponding manner by a control unit. Thus, it is made possible, in case of a change of the pressure difference prevailing at the cryopumps, to correct this difference by opening the supply valve or by opening the return valve.

In a particularly preferred embodiment, the defining of the switching value or the switching range, i.e. of the maximum and minimum switching value, for the control of the supply and/or return valve is performed in dependence on a refrigeration generator characteristic line. In this process, it is to be observed that, due to the constructional design of the cryopump, the pressure measured on the high-pressure side is an indicator of the respective pressure difference. This will depend on the type of the cryopumps and, possibly, on further accompanying conditions.

According to a preferred embodiment, the supply valve, the return valve and the pressure measurement device are all connected to the control unit.

According to a further embodiment, the return valve is replaced by a nozzle which preferably has a small orifice. Once a corresponding pressure difference exists, medium will flow through this nozzle from the storage container into the medium return conduits. The provision of such a nozzle advantageously obviates the need for a return valve. This allows for a further reduction of costs. The nozzle has a diameter of e.g. 0.3 mm, with a high pressure of about 20 bar and a low pressure of about 5 bar occurring in the system. The pressure in the storage container will be 5-20 bar, depending on the condition of the vacuum device.

The present invention further relates to methods for controlling of the above described refrigeration devices.

In a first method according to the invention, when a maximum threshold value measured by the pressure measurement device is exceeded, the supply valve is opened so that medium will flow into the storage container. According to the invention, when the pressure falls below a minimum threshold value, the return valve is opened so that medium will flow from the storage container into the return conduits. In this manner, a substantially constant pressure difference can be maintained at the cryopumps(s).

A second method according to the invention serves for operating a vacuum device wherein a nozzle is provided instead of the return valve. In this method, a corresponding pressure difference between the storage container and the return conduit will cause medium to flow into the medium return conduit until, due to the change of the pressure difference at the cryopumps, the pressure in the medium supply conduit exceeds the maximum threshold value. This is followed by a repetition of the first method step wherein, when the maximum threshold value is exceeded, the supply valve will be opened to thus cause medium to flow into the storage container.

In both of the above methods, it is possible that the one or plural compressor devices will deliver the medium constantly. A complex controlling of the compressor devices is thus not necessitated.

Still further advantages of the present invention will be appreciated to those of ordinary skill in the art upon reading and understand the following detailed description.

### BRIEF DESCRIPTION OF THE DRAWINGS

The FIGURE shows a schematic view of a vacuum device.

### DETAILED DESCRIPTION

The vacuum device comprises a plurality of cryopumps 10 arranged in parallel to each other. These cryopumps 10 are connected to each other via branched medium supply conduits 12 so that the individual cryopumps are arranged in parallel to each other. The outlets of the one or plural cryopumps 10 are joined by entering a common medium return conduit 14. In the illustrated embodiment, the medium supply conduit 12 is connected to two compressor devices 16 by which the compressed refrigerating medium, normally helium, is generated to then be guided—in the direction marked by the arrows—towards the cryopumps 10. Via the medium return conduit 14, the medium expanded in the cryopumps 10 will be returned to the compressor devices 16 through conduits 18. In the process, the medium can be cleansed, if required, by a cleansing device (not illustrated) after having passed through the compressors 16.

The refrigeration device further comprises a storage container 20. Storage container 20 is connected to the medium supply conduit 12 or the medium return conduit 14 via connection conduits 22,24.

In the illustrated embodiment, connection conduit 22 is provided with a controllable valve 26, and connection conduit 24 is provided with a nozzle 28. Further, the medium supply conduit 12 has a pressure measurement device 30 arranged therein.

In the FIGURE, the flow direction of the medium in the individual conduits has been marked by an arrow.

Further, a control unit 32 is provided which via lines 34,36, graphically represented by interrupted lines, is connected to the pressure measurement device 30 and the valve 26, respectively.

During operation of the illustrated vacuum device, a pressure is built up by means of the compressors 16, preferably before the cryopump is switched on. Thereafter, by switching-on of the cryopump, one or a plurality of refrigeration chambers connected to the refrigeration device via cryopumps 10 will be refrigerated. For this purpose, the refrigeration medium, i.e. normally helium, is pumped from the compressor devices 16 in the direction of the arrows through the medium supply conduit 12 to the cryopumps 10. Within the cryopumps 10, the medium will expand and then be returned again to the compressor devices 16 via the medium return conduit 14 and the conduits 18.

For keeping the pressure difference at the cryopumps as constant as possible, the pressure prevailing in the medium supply conduit 12 is monitored by the pressure measurement device 30. If the pressure in the medium supply conduit 12 exceeds a predetermined maximum threshold value, this occurrence will be communicated to control unit 32 or be detected by the latter, and a corresponding signal will be emitted to the supply valve 26 via line 36. For this purpose, supply valve 26 will be opened, and a part of the medium issued from the compressor devices 16 will flow into storage container 20. This will effect a reduction of the pressure in the medium supply conduits 12.

If the pressure between the storage container 20 and the medium return conduits 14 reaches a pressure difference, medium will flow through nozzle 28 into the return conduits 14 and on to the outlets of cryopump 10. In this manner, there is performed an automatic control of the pressure difference at the cryopumps 10.

As soon as the pressure in the medium supply conduit 12 drops below a predetermined minimum threshold value, valve 26 will be closed again by control unit 32. To safeguard a smooth functioning of this controlling process, valve 26 has an orifice of a distinctly larger cross section than nozzle 28.

According to a second embodiment of the vacuum device of the invention, nozzle 28 is replaced by a return valve connected to control unit 32.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A vacuum device comprising
a plurality of refrigeration devices,
a compressor device connected to the refrigeration devices via medium supply conduits,
medium return conduits connected to the refrigeration devices and the compressor device,
a storage container connected to the medium supply conduits and the medium return conduits via connection conduits,
a supply valve arranged in the connection conduit between the medium supply conduits and the storage containers,
a pressure measurement device provided only in the medium supply conduit or only in the medium return conduit,
a control unit connected to the pressure measurement device for measuring the pressure of the medium and to the supply valve, the control unit controlling the supply valve in dependence on the measured pressure.

2. The vacuum device according to claim 1, further including determining a threshold value or threshold range for controlling the supply valve in dependence on a refrigeration-device characteristic line.

3. The vacuum device according to claim 1, further including a return valve connected to the control unit and arranged in the connection conduit between the medium return conduit and the storage container.

4. The vacuum device according to claim 1, further including a nozzle with a small orifice arranged in the connection conduit between the medium return conduit and the storage container.

5. A method for controlling a vacuum device as defined in claim 1, wherein,
if the pressure measured by the pressure measurement device exceeds a maximum threshold value, the supply valve is opened to cause medium to flow into the storage container, and
if the pressure measured by the pressure measurement device falls below a minimum threshold value, the return valve is opened to cause medium to flow from the storage container into the medium return conduit.

6. A method for controlling a vacuum device as defined in claim 1, wherein,
if the pressure measured by the pressure measurement device exceeds a maximum threshold value, the supply valve is opened to cause medium to flow into the storage container, and
in case of a corresponding pressure difference, medium is caused to flow through a nozzle into the medium return conduit until, due to the change of the pressure difference at the refrigeration de-vices, the pressure in the medium supply conduit exceeds the maximum threshold value.

7. The method for controlling a vacuum device according to claim 5, wherein the supply of medium by means of the compressor device is continuous.

8. The method for controlling a vacuum device according claim 5, wherein medium is supplied from the storage container only to the medium return conduits.

9. The method for controlling a vacuum device according to claim 6, wherein the supply of medium by means of the compressor device is continuous.

10. The method for controlling a vacuum device according to claim 6, wherein medium is supplied from the storage container only to the medium return conduits.

11. A vacuum system comprising:
a plurality of refrigeration devices;
medium supply conduits which supply a refrigeration medium to the refrigeration devices in parallel;
a compressor which supplies the refrigeration medium to the medium supply conduits in a compressed state at a supply pressure;
medium return conduits which return the refrigeration medium from the refrigeration devices to the compressor at a return pressure lower than the supply pressure;
a storage container for storing refrigeration medium;
a first valve which supplies refrigeration medium from the medium supply conduits to the storage container in response to one of the supply pressure in the medium supply conduits exceeding a supply pressure threshold or the return pressure in the medium return conduits falling below a return pressure threshold, reducing the supply pressure in the medium supply conduits;
a nozzle or valve which supplies refrigeration medium from the storage container into the medium return lines when pressure in the storage container exceeds the return pressure, raising the return pressure;
whereby a pressure differential between the supply pressure and the return pressure is maintained without measuring both the supply pressure and the return pressure.
